(19) United States
(12) Patent Application Publication
(10) Pub. No.: US 2005/0046787 A1
(43) Pub. Date: Mar. 3, 2005

(54) System for comfortable and aesthetic eyewear

(75) Inventor: Philipp Damjanovic, University Park, PA (US)

Correspondence Address: Philipp Damjanovic, 416 Simmons, University Park, PA, 16802, US

(73) Assignee: Philipp Damjanovic, University Park, PA (US)

(21) Appl. No.: 10/651,108

(22) Filed: Aug. 29, 2003

(51) Int. Cl. G02C 1/00

(52) U.S. Cl. 351/65

(57) ABSTRACT

This invention, a system of eyewear without sidepieces and employing a noseclip, nosepiece, or nosebridge which can apply enough pressure to a person's nose to retain an article of eyewear without sidepieces to a person's head, is both more comfortable to wear and more aesthetically pleasing than many forms of current eyewear.

### CROSS-REFERENCE TO RELATED APPLICATIONS

Not applicable

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable

### BACKGROUND OF THE INVENTION

Eyewear is traditionally worn with the aid of sidepieces/temples, which usually hook behind, and rest on top of, a wearer's ears and also aid in balancing the eyewear on a wearer's face. However, such sidepieces often become irritating to the wearer, especially when they are incorrectly made, and sometimes do not look aesthetically pleasing. Furthermore, the nature of the wide variety in size and shape of the human head means that often eyewear, which is produced according to certain standard stock sizes, is either too large or too small for a wearer's head. This can result in pain and stress headaches for the wearer in the former case and eyewear that can fall off the wearer's head and be damaged in the latter case. Furthermore, incorrectly made sidepieces may cause abrasion on the skin of the ears and stress pain on the ears of a wearer, where the sidepieces may come in contact with the ears.

### BRIEF SUMMARY OF THE INVENTION

My invention has obviated the problems stated above by not having any sidepieces at all. The method of attachment to a wearer's face is usually through the use of a particular type of nosepiece that grips the wearer's nose. Such nosepieces may vary in design, but all such nosepieces feature some form of clip system whereby two opposite clips apply pressure to the left and right sides of the bony part of the human nose, and apply enough pressure to allow an article of eyewear to be worn comfortably on the nose without fear of the eyewear falling off. Another strong improvement of this design is that the lack of sidepieces serves to make any eyewear inherently more aesthetically pleasing. The two central features and underlying ideas of this invention are the removal of the sidepieces on an article of eyewear in order to make such eyewear more aesthetic and lighter (and therefore more comfortable and healthier to wear), and a nosepiece that uses oppositely acting pressure-applying clips or pads to retain the eyewear to a wearer's head.

### BRIEF DESCRIPTION OF THE SEVERAL DRAWINGS

No drawings necessary

### DETAILED DESCRIPTION OF THE INVENTION

Eyewear can be manufactured using a variety of means and out of a variety of materials. Popular materials include plastics and metals (including nickel and titanium) for the frames (of which the nosebridge/noseclip and sidepieces are considered a part), and plastics and various types of glass for the lenses. Since my invention does not affect the lenses of eyewear in any way, I will not concern myself with the manufacture of lenses in this description. However, my invention does affect the frame. Frames can be manufactured out of plastic or metal through a cast-mould process whereby the material to be used is poured into/placed into a mould and then shaped to the desired shape. To manufacture a frame such as would be used in an article of eyewear as I have invented, a manufacturer would simply have to redesign the mould such that it would produce frames that do not have sidepieces/temples. It should be noted that in order to produce frames, such as would be used in an article of eyewear of my invention, there is no new process or technology that is needed. A manufacturer simply need adjust his/her current methods so that sidepieces are not produced. Other methods of production may include hand-made production and mechanized-robotic production, whereby some form of computer-controlled automaton is used to either assist in, or to completely manufacture a frame out of plastic or metal. Once again, a manufacturer simply need change the method of hand production or re-program automated production such that sidepieces are not produced on the frames of the eyewear.

The noseclip/nosepiece/nosebridge that would be required to make such an article of eyewear functional can also be produced by a number of means. A most simple and common design would involve a C-shaped metal wire with rubber pads at either end, this wire being able to provide enough inward pressure as to be able to hold an article of eyewear firmly on a person's nose when the ends are slid over the top of a wearer's nose. The metal used in the wire would have to be malleable, yet resistant to long-term deformation. Possibilities include nickel and gold alloys. Another form of noseclip could consist of a single moulded piece of form-fitting rubber, which would conform to the shape of a wearer's nose and provide grip at the same time. The surface that is in contact with the wearer's nose could be dimpled for extra grip.

The details of the changes required in the methods of production are usually only known to the manufacturers themselves, and are readily obvious and apparent to them.

1. An article of eyewear that does not have any sidepieces, straps, or temple-pieces which may apply pressure, force, or stress anywhere on or around the human head (irrespective of the eyewear's style or design).

2. A noseclip, nosebridge, or nosepiece that can hold an article of eyewear which does not have sidepieces, straps, or temple-pieces to the nose of a wearer of such an article of eyewear through the application of pressure onto the left and right sides of the wearer's nose.
